(19) United States
(12) Patent Application Publication
(10) Pub. No.: US 2011/0145007 A1
(43) Pub. Date: Jun. 16, 2011

(54) System and method for automated payment of insurance claims via real-time exchange of information

(76) Inventor: Itamar Romanini, Sheboyean, WI (US)

(21) Appl. No.: 12/653,659

(22) Filed: Dec. 15, 2009

(51) Int. Cl. G06Q 40/00; G06Q 50/00; G06Q 20/00

(52) U.S. Cl. 705/2; 705/4

(57) ABSTRACT

A system for real-time provider reimbursement of insurance claims is provided and includes an insurance system server for storing information regarding a member, and for receiving information regarding reimbursement of insurance claims. The information regarding reimbursement of insurance claims is received from a computer associated with a member. The system further includes a first financial institution server for generating information regarding a health savings account, a second financial institution computer for receiving electronic funds from the health savings account, and for receiving funds from a credit card account of or associated with the member. The system determines whether the insurance claim is selected for reimbursement, and determines whether the insurance claim meets pre-determined criteria, where the system initiates an electronic funds transfer from the health savings account to the second financial institution if the insurance claim is selected for reimbursement and the insurance claim meets the predetermined criteria.

### FIELD OF THE INVENTION

The invention relates generally to a system and method for automated payment of insurance claims, and particularly, to the automated payment of insurance claims via a debit card, after adjudication, through real-time information exchange between an insurance carrier or another third-party adjudicator and a financial institution.

### BACKGROUND OF THE INVENTION

Health insurance has become the prevalent method for paying for healthcare related services and products. For insurance companies who underwrite these health insurance policies, it has become necessary to ensure that they timely process health insurance claims information from healthcare providers so that unnecessary costs associated with processing these health insurance claims stay as low as possible.

Consumers having health insurance are required to present an insurance card evidencing proof of health insurance. Information from the insurance card is used to determine the initial copay amount, if any, that must be paid by the consumer or agree to pay, for example, a hospital, the amount which is not covered by health insurance before healthcare related services or products are provided. In recent times, some healthcare related services have been paid either through a Health Savings Account (“HSA”) associated with a Consumer Driven Healthcare Plan, or a Flexible Spending Account. The HSA is a tax-advantaged medical savings account available to taxpayers who are enrolled in a High Deductible Health Plan (HDHP). The funds contributed to the account are not subject to federal income tax at the time of deposit. Unlike a flexible spending account (FSA), funds roll over and accumulate year to year if not spent. HSA's are owned by the individual, which differentiates them from the company-owned Health Reimbursement Arrangement (HRA) that is an alternate tax-deductible source of funds paired with HDHP's. Funds may be used to pay for qualified medical expenses at any time without federal tax liability. Withdrawals for non-medical expenses are treated very similarly to those in an IRA in that they may provide tax advantages if taken after retirement age, and they incur penalties if taken earlier. An HSA may be utilized by paper claims or by using an HSA debit card.

Healthcare providers submit insurance claims to health insurance plans for payment and sometimes face the uncertainty that some of these insurance claims may not be covered by health insurance, and risk going unpaid. Additionally, there is uncertainty to the consumer about how much of the final insurance claim costs will be covered by health insurance. Insurance providers determine these costs through claims adjudication. Importantly, claim adjudication requires a determination of the health insurance plan's financial responsibility to the healthcare provider. As adjudication of healthcare related services does not occur in real-time, both of these constituents may have to wait for these processes to complete. The amount for healthcare costs that is not paid by the insurance plan must be paid for by the consumer. Although the consumer can greatly reduce his financial responsibility through using the HSA, however, regardless of using the HSA, the delays in adjudication will unnecessarily add further costs to the consumer through increased provider costs, etc. Moreover, more insurance plans will decide to pass these added costs to the consumer through increased premiums, or less amounts covered for each claim. Therefore, a process of automated payment of insurance claims would streamline the adjudication process greatly.

In view of the foregoing, a need exists for an improved system and method for adjudicating insurance claims received from healthcare providers as well as payment of insurance claims from insurance carrier to medical provider in a timely manner.

### SUMMARY OF THE INVENTION

The present invention relates to a system for real-time provision of reimbursement of insurance claims. Generally, the system includes an insurance system server for storing information regarding a member, and for receiving information regarding reimbursement of insurance claims. The information regarding reimbursement of insurance claims is received from a computer associated with a member. The system further includes a first financial institution server for generating information regarding a health savings account, a second financial institution computer for receiving electronic funds from the health savings account, and for receiving funds from either a credit or debit card account of or associated with the member. The system determines whether the insurance claim is selected for reimbursement, and determines whether the insurance claim meets pre-determined criteria, where the system initiates an electronic funds transfer from the health savings account to the second financial institution if the insurance claim is selected for reimbursement and the insurance claim meets the predetermined criteria.

An object of the invention is to overcome these and other drawbacks of real-time information exchange between an insurance provider or another third-party adjudicator and a financial institution.

Another object of the invention is to provide automated payment of insurance claims after adjudication.

Another object of the invention is to provide a debit or credit card processing option as a payment channel for real-time integrated payments of insurance claims.

Another object of the invention is to link a health savings account with an insurance plan for automated payment of insurance claims.

In a first non-limiting embodiment of the invention, a system for member reimbursement of insurance claims is provided and includes an insurance system server for storing information regarding a member account, and for receiving information regarding reimbursement of insurance claims, where the insurance system server is of or associated with a third party. The information regarding reimbursement is received from a computer of or associated with a member. The system further includes a first financial institution server for generating information regarding a health savings account, a second financial institution computer for receiving electronic transfer of funds from the health savings account. The system determines whether the insurance claim is selected for reimbursement, and initiates an electronic funds transfer from the health savings account to the second financial institution if the insurance claim is selected for reimbursement.

In a second non-limiting embodiment of the invention, a system for real-time provider reimbursement of insurance claims is provided and includes an insurance system server for storing information regarding a member, and for receiving information regarding reimbursement of insurance claims, where the insurance system server is of or associated with a third party. The information regarding reimbursement of insurance claims is received from a computer of or associated with a member. The system further includes a first financial institution server for generating information regarding a health savings account, a second financial institution computer for receiving electronic funds from the health savings account, and for receiving funds from a debit or credit card account of or associated with the member. The system determines whether the insurance claim is selected for reimbursement, and determines whether the insurance claim meets pre-determined criteria, where the system initiates an electronic funds transfer from the health savings account to the second financial institution if the insurance claim is selected for reimbursement and the insurance claim meets the predetermined criteria.

In a third non-limiting embodiment of the invention, a method for real-time processing of insurance claims is provided and includes six steps. In step one, information regarding a member is stored in a storage device. In step two, information regarding reimbursement of insurance claims is received, where the insurance system server is of or associated with a third party, and where the information regarding reimbursement of insurance claims is received from a computer of or associated with a member. In step three, information regarding a health savings account is generated, where the health savings account is of or associated with said member. In step four, electronic funds from the health savings account is received, and or funds from a debit or credit card account of or associated with the member is received. In step five, a determination is made whether the insurance claim is selected for reimbursement, and whether the insurance claim meets pre-determined criteria. In step six, an electronic funds transfer from the health savings account to the second financial institution is initiated if the insurance claim is selected for reimbursement and the insurance claim meets the predetermined criteria.

Other objects, features, and characteristics of the invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the invention can be obtained by reference to a preferred embodiment set forth in the illustrations of the accompanying drawings. Although the illustrated embodiment is merely exemplary of systems for carrying out the invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the invention, reference is now made to the following drawings in which:

FIG. 1 is a schematic diagram illustrating a system for linking a member to a HSA administered bank, an insurance provider, and a healthcare provider for providing automated payment of insurance claims according to a preferred embodiment of the invention.

FIG. 2 is a flow chart illustrating the process of member enrollment according to the preferred embodiment of the invention.

FIG. 3 is a flow chart illustrating the process of modifying a claims payment option according to the preferred embodiment of the invention.

FIG. 4 is a flow chart illustrating the process of modifying a user profile according to the preferred embodiment of the invention.

FIG. 5 is a flow chart illustrating the process of member reimbursement according to the preferred embodiment of the invention.

FIG. 6 is a flow chart illustrating the process of provider reimbursement according to the preferred embodiment of the invention.

### DETAILED DESCRIPTION OF THE DRAWINGS

As required, a detailed illustrative embodiment of the invention is disclosed herein. However, techniques, systems, and operating structures in accordance with the invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the invention. The following presents a detailed description of the preferred embodiment of the invention.

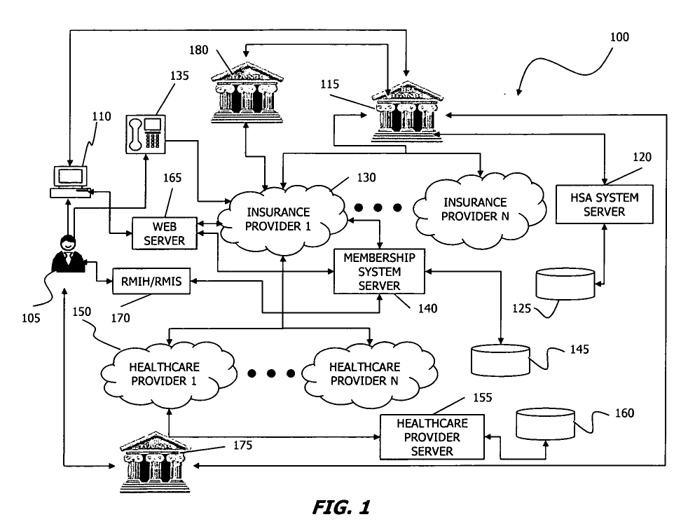

Referring to FIG. 1, shown is a system 100 for implementing the linkage of healthcare-related information from, in one non-limiting example, at least one insurance provider 130 with at least one healthcare provider 150, although in other non-limiting embodiments, system 100 may be provided for linking information from a third-party responsible for adjudication and payment on behalf of the insurance provider 130 with at least one healthcare provider 150. As shown, the system 100 is utilized by each of the insurance provider 130, healthcare provider 150, and member 105 for exchange of information required for providing automated payment of insurance claims for medical services and products according to a preferred embodiment of the invention. Particularly, the system 100 includes at least one user workstation 110 for use by member 105 to create, edit, and monitor information regarding a Health Savings Account (HSA). The member 105 may utilize user workstation 110 to create the HSA by accessing an online web page provided or associated with a financial institution such as, for example, primary bank 115 for transmitting member information, across the Internet network, which is required in order to create the HSA. In one non-limiting embodiment, a portable device or other similar type of device may be utilized to transmit member information. Member information, such as, for example, member identification information, periodic percentage contributions information, etc., is entered at user workstation 110 and is transmitted across a wireless or wired network to primary bank 115. Primary bank 115 administers HSA accounts for a plurality of members upon receiving information necessary to create the respective HSA accounts. It should be appreciated that the HSA being administered by primary bank 115 may be used to pay for “qualified expenses” under the IRS Tax Code and other governmental regulations. It should also be appreciated that multiple networks may be used to transmit information, and that some or all of these networks may be private, dedicated networks in addition to the use of public networks such as the Internet.

System server 120, residing at primary bank 115, being a network server utilizes a processing module for processing information received to create the HSA. System server 120 is also utilized to provide member 105 to access to the HSA, once created, as will be shown and described below. Primary bank 115 maintains all information associated with its HSA administered accounts in database 125 for each respective member, such as member 105, with system server 120 processing transactions and/or calculations for providing access to the information through database 125. Primary bank 115 also transmits this information to the respective insurance providers that are associated with each of members that have an HSA at primary bank 115.

Further, primary bank 115 is connected to at least one insurance provider 130 through a network connection. The insurance provider 130 is typical of insurance providers, with insurance provider 130 administering the healthcare insurance plan for member 105. The healthcare insurance plan typically has defined healthcare benefits, payment costs, and preferred health care providers with which it has fee agreements. These are stored in storage database 145 and connected to membership system server 140 for access and processing. Membership system server 140 interfaces with storage database 145 to provide secure storage and access to all information associated with member 105. The membership system server 140 facilitates processing claims information related to claims adjudication, including reimbursement once the adjudication process has been completed. Also, membership system server 140, being a network server, includes a processing module for processing HSA enrollment information received from primary bank 115, and for processing information regarding payment options selected by member 105 once the HSA associated with member 105 has been created.

Connected to membership system server 140 is web server 165. Web server 165 interfaces with membership system server 140 to deliver information regarding member 105 through a web page (HTML document). Web server 165 also receives information from member 105 through the web page, with this received information being stored in data storage in communication with web server 165. The received information is also uploaded to membership system server 140.

Further, Records Management Information Service 170 (“RMIS”) is a web service connected to membership system server 140 that delivers web pages and associated content (e.g. images, style sheets, JavaScripts) to member 105 for viewing. RMIS 170 contains software embedded in hardware designed to support interoperable machine-to-machine interaction over a network and is used to track and store records and retrieves data records from membership system server 140 for presentation to member 105 on a GUI at user workstation 110. Information related to claim processing may be received by member 105 utilizing user workstation 110. The member 105 using GUI, such as a web browser or web crawler, may make a request for, in one example all pending claims submitted by, in one example, healthcare provider 150, although in other non-limiting embodiments, member 105 may review all claims submitted by any third-party. The RMIS 170 may respond with the requested content in a web page for viewing, or selection and reimbursement by member 105. It should be appreciated that the network interfacing the insurance provider 130 to member 105, primary bank 115, and healthcare provider 150 may be implemented using the Internet, an intranet, a wide area network (WAN), a local area network (LAN), a virtual private network, or any combination of the foregoing. The networks may include both wired and wireless connections, including optical links. As an example, the user workstations 110 may include portable wireless terminals (stationary or mobile) linked to primary bank 115 by wireless communication channels.

The system 100 further includes telephone 135 in communication with a switchboard device for routing calls from member 105 to insurance provider 130. Member 105 may utilize telephone 135 to connect with a Customer Service Representative (“CSR”) associated with the insurance provider 130. Information received by CSR is directly inputted into membership system server 140 and updated in database 145.

Insurance provider 130 is further connected to healthcare provider 150 through a network connection. Claims information may be transmitted from healthcare provider 150 while reimbursement for healthcare-related expenses may be transmitted from insurance provider 130, with information being transmitted in real-time between the healthcare provider 150 and the insurance provider 130. The healthcare provider 150 transmits data relating to insurance claims for payment, and the healthcare provider 150 may be affiliated with a different third party and links systems, terminals, and databases with the insurance provider 130. The healthcare provider 150 may maintain all information associated with its claims in database 160 for each respective member, such as member 105, with healthcare provider server 155 processing transactions and/or calculations for providing access to the information through database 160. Database 160 may store data such as claims history, pending claims, permitted charges (e.g., negotiated charges for particular treatment plans, etc.), deductibles, co-pays, and other information used for processing claims and generating explanation of benefits (“EOB”) or explanation of payment (“EOP”). This data stored in database 160 may be retrieved or edited through a database management system (“DBMS”). Financial institution 175 is associated with member 105 and may be utilized for handling automated clearing house type transactions for transferring payments to member 105 (for example, member bank) from primary bank 115 or originating conventional credit card, debit card, or other similar types of transactions for transferring payment to member 105. Similarly, financial institution 180, being affiliated with insurance provider 130, may be utilized for healthcare provider 150 reimbursement through ACH transfer of funds from Primary bank 115 to financial institution 180 or other conventional credit card, debit card or other similar financial transactions that are originated by insurance provider 130 for receipt of payment from member 105 and subsequent payment to healthcare provider 150.

Each of the network servers 120, 140, and 155 may have substantially similar system architectures and a description of system server 120 provides a description of the network server at insurance provider 130 and Healthcare provider 155.

Accordingly, system server 120 includes at least one controller or processing module (CPU or processor), at least one communications module port or hub, at least one random access memory module and one or more data storage modules. All of these latter elements are in communication with the processing module to facilitate the operation of the network server. The system server 120 may be a conventional standalone server, although in other embodiments, the function of the server may be distributed across multiple computing systems and architectures.

The processing module is in communication with data storage module, such as database 125 for storage of user information as well as processing transactions through a DBMS. The DBMS and database 125 may include any one of numerous forms of storage devices and storage media, such as solid-state memory (RAM, ROM, PROM, and the like), magnetic memory, such as disc drives, tape storage, and the like, and/or optical memory, such as DVD. The database 125 may be co-located with the DBMS, or it may represent (with DBMS) distributed data systems located remotely in various different systems and locations.

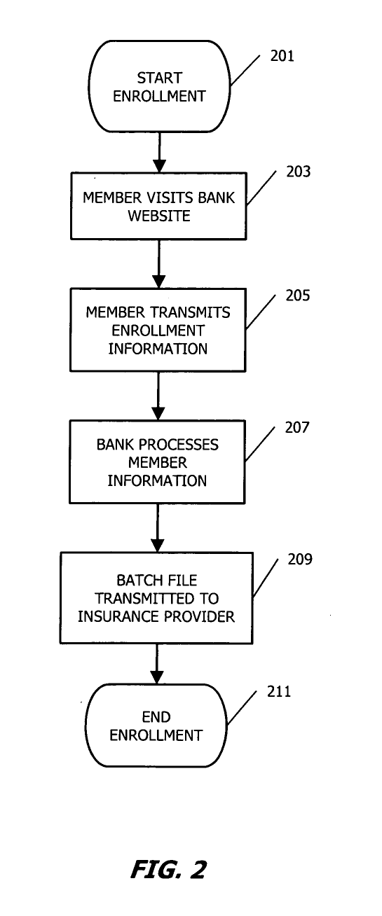

Referring next to FIG. 2, shown is a flow diagram depicting the process steps utilized for creating a bank affiliated HSA in system 100. The process begins at step 201 and proceeds to step 203 where member 105 utilizes user workstation 110 to access a website associated with Primary bank 115. The member 105 utilizes a Graphical User Interface to access a web page provided by the website. Next, in step 205, member 105 inputs enrollment information, for example identification data, percentage contributions, payment options, or similar type of information into the GUI for transmission to Primary bank 115. Also, member 105 may preselect an option to reimburse healthcare provider 150 on a claim-by-claim basis, where member 105 identifies and selects a particular claim for reimbursement, or automatic reimbursement for all pending insurance claims without member 105 input. Next, in step 207, Primary bank 115 processes the received information to create an HSA associated with member 105 and issues a debit card to member 105. Debit card may be utilized by member for all healthcare related expenses with funds being depleted from the HSA account for member 105 charges. Also, system server 120 stores data records representing member enrollment data associated with the HSA in database 125. Next, in step 209, primary bank 115 transmits the enrollment file representing member enrollment information as a batch file to the respective insurance providers that are associated with each of members that have an HSA account at Primary bank 115. Primary bank 115 also sends credit-card information for member 105 to a third-party provider of electronic payment and transaction-processing services for processing charges exceeding the balance limits in the HSA. The process ends in step 211.

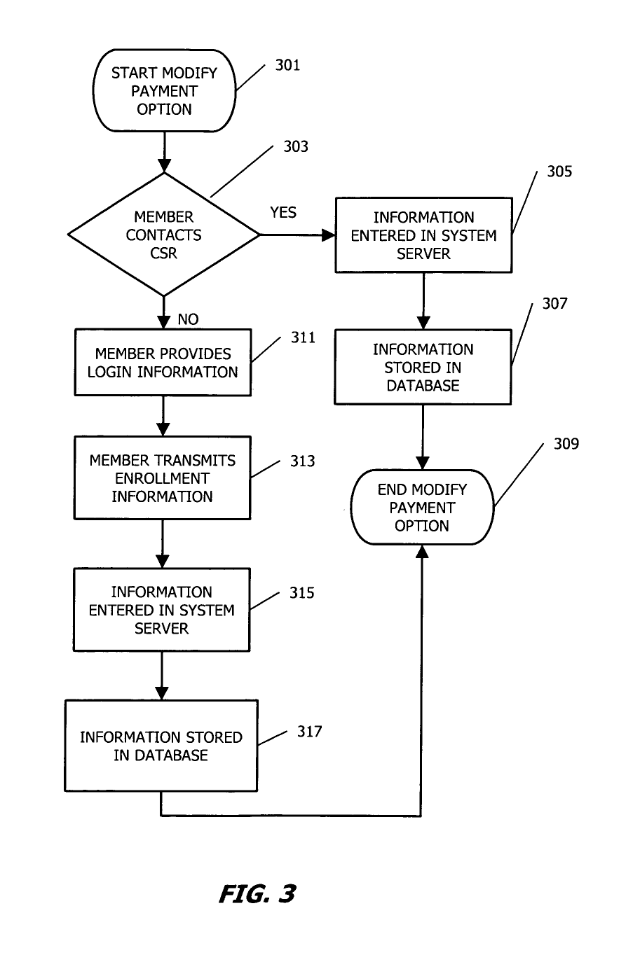

Referring now to FIG. 3, shown in a flow diagram depicting the steps for modifying payment options for reimbursing healthcare provider 150. The process begins in step 301 where member 105 may selectively determine whether to authorize payment to healthcare provider 150 on a claim-by-claim basis or preauthorize payment for all claims prior to receiving a communication from the insurance provider 130. The member 105 may have several options to change payment option; member 105 may utilize user workstation 110 to access an insurance web page associated with or provided by insurance provider 130, member 105 may utilize user workstation 110 to access a webpage associated with an HSA account at primary bank 115, or use a telephone connection to speak with a Customer Service Representative (“CSR”) associated with the insurance provider 130 or to a CSR associated with primary bank 115. In step 303, if member 105 chooses to speak with a CSR through a telephone connection, then in step 305, member 105 provides reimbursement changes to the CSR for manual input by the CSR into membership system server 140. In step 307, membership system server 140, through computer software, interfaces with storage database 145 to store the updates in database 145. However, if member 105 prefers to access member's account through an online login in order to make the payment option updates, then in step 311, member 105, utilizing user workstation 110, accesses website supported by insurance provider 130 to gain access to the member account and provides login information. The insurance website is an online resource to enable member 105 to manage information associated with insurance information, including the HSA, through a convenient online web page that provides access to both insurance information as well as HSA information received from Primary bank 115. Next, in step 313, payment option information transmitted by member 105 through the website is received by web server and, in step 315, uploaded to membership system server 140. In step 317, Membership system server 140 interfaces with storage database 145 to store the updated information. The modifying payment options process ends in step 309.

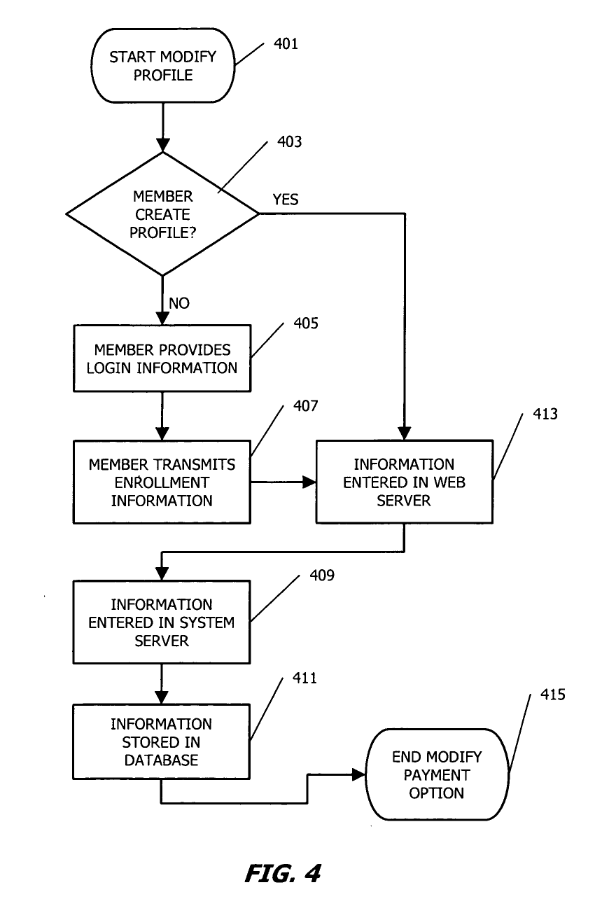

Referring to FIG. 4, shown is a flow diagram for depicting the steps for modifying member profile utilizing system 100. The process begins in step 401 where member 105 may utilize system 100 to create a new profile or modify an existing profile stored in database 155 at insurance provider 130. In step 403, if member 105 needs to create a new insurance profile, then in step 413, member 105 transmits membership information via the insurance web page to a web server. However, if member 105 has an existing account at insurance provider 130, then in step 405, member 130 utilizes user workstation 110 to access the web page and provide login information to gain access to the member account. Next, in step 407, member 105 transmits membership information via the web page. Continuing back to step 413, membership related data, which is transmitted to web server 165 is transferred to membership system server 140 for processing. Membership system server 140 includes processing systems coupled to storage to process the information received and create information for a user profile to identify member 105. Next, in step 411, information created is stored in storage database 145 to provide secure storage and access to all information associated with member 105. The modifying member profile process ends in step 415.

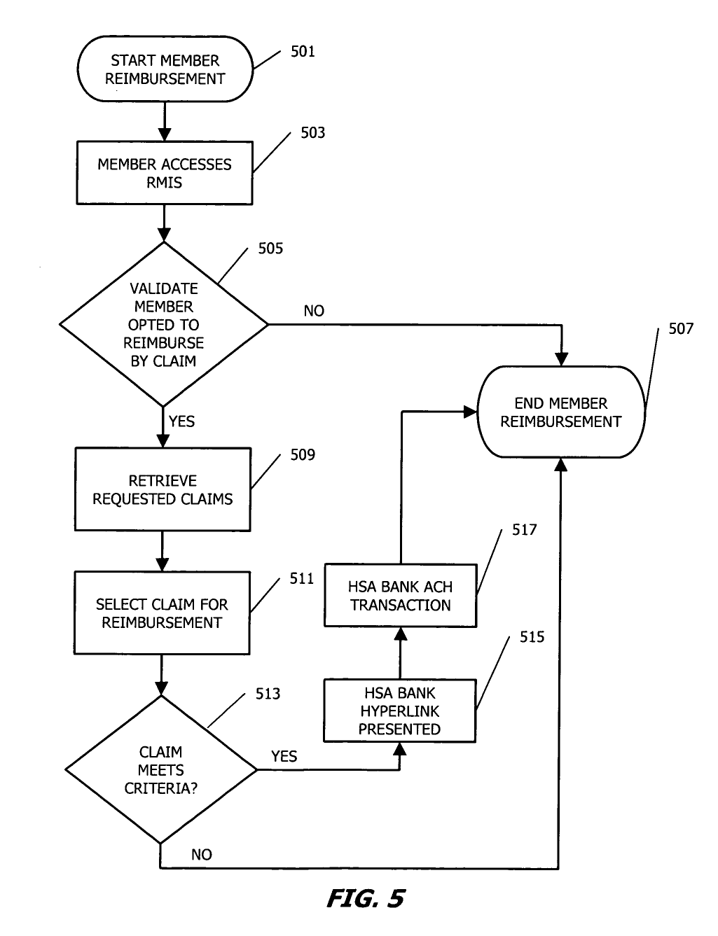

Member reimbursement for health related expenses is shown in FIG. 5 and begins in step 501 after the member 105 has received healthcare related services or products from healthcare provider 150 and has paid for these without using funds from the HSA. Member 105 utilizes system 100 to access insurance claims submitted by the healthcare provider 150 and after the insurance provider 130 has adjudicated the claim and provided an Explanation of benefits (“EOB”) to member through member 105 online account or through a paper copy. Next, in step 503, member 105 may utilize the user workstation 110 to connect to RMIS 170 or a similar web service application to access member information. Next, in step 505, RMIS 170 determines whether member 105 opted to reimburse by claim (i.e., pay by claim indicator is “yes”) by retrieving the relevant claim history records from database 145 that is accessed through membership system server 140. If the pay by claim indicator is “yes”, then in step 509, the relevant claims requested by member 105 are retrieved from database 145 and presented to member 105 in the GUI. However, if the pay by claim indicator is “no”, then member had previously preauthorized payment for all claims and no claim information for approval is returned to member 105 and the process ends in step 507. Continuing from step 509, next in step 511, member 105 selects the particular claim for reimbursement. In step 513, membership system server 140 determines whether the selected claim meets the criteria for reimbursement. The membership system server 140 looks at several criteria, such as patient liability being greater than zero, Consumer Driven Healthcare Plan (“CDHP”) reimbursed expenses paid, whether member 105 has an HSA account?, etc. If the answer is yes, then in step 515, information for accessing a web link of Primary bank 115 is presented to member 105 for selection. The member 105 notes subscriber liability amounts and, in step 517, selects the hyperlink to authorize Primary bank 115 to forward an electronic credit to financial institution 175 associated with a personal financial account of member 105, for example, by means of the banking industry standard fashion, such as an Electronic Funds Transfer (“EFT”) processed through an Automated Clearing House (“ACH”). The process ends in step 507. However, if the answer to determining claim criteria of step 513 is no, then no claim information is presented and the process ends in step 507.

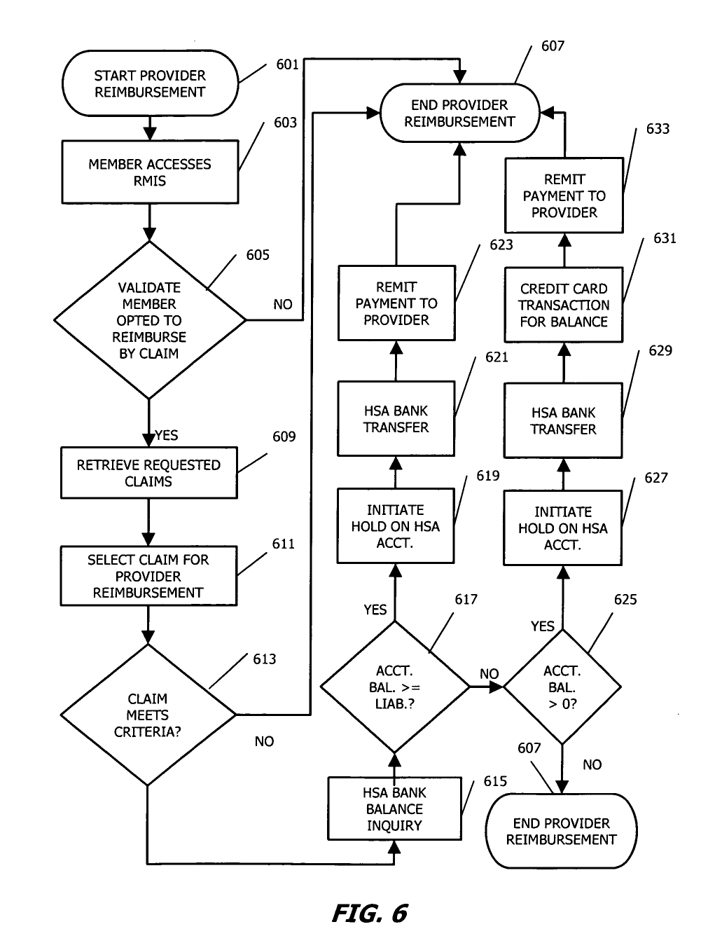

Referring now to FIG. 6, reimbursing healthcare provider 150 is shown in FIG. 6 and begins in step 601 after the member 105 has received healthcare related services or products from healthcare provider 150 and at least one insurance claim has been submitted by the healthcare provider 150 to insurance provider 130 for claims adjudication. Next, in step 603, member 105 utilizes user workstation 110 to connect to RMIS 170 or similar web service application to access member information. Next, in step 605, RMIS 170 determines whether member 105 opted to reimburse by claim (i.e., pay by claim indicator is “yes”) by retrieving the relevant claims history record from database 145 and which interfaces to membership system server 140. If the pay by claim indicator is “yes”, then in step 609, the relevant claims, requested by member 105, are retrieved from database 145 and presented to member 105 in the GUI. However, if the pay by claim indicator is “no”, then member had previously preauthorized payment for all claims and no claim information for approval is returned to member 105 and the process ends in step 607.

Continuing from step 609, next in step 611, member 105 selects the particular claim for reimbursing provider. In step 613, membership system server 140 determines whether the selected claim meets the criteria for reimbursement by looking at several criteria, such as, in one non-limiting example, whether patient liability is greater than zero, whether they are Consumer Directed Healthcare Plan expenses paid, whether HSA product code is on, whether member 105 has an HSA account, whether this claim has dates of service within HSA effective date, etc. The membership system further determines the percentage of the claim that is payable by the member (i.e., member liability). If the answer is yes, then in step 615, a balance inquiry is sent in real-time from web server 165 to primary bank 115. Next, in step 617, web server 165 receives the balance inquiry and membership system server 140 determines whether the account balance is greater than patient liability. If the answer is yes, then in step 619, membership system server 140 initiates a memo post transaction to Primary bank 115 to hold the funds for patient liability associated with member account. The memo post may be initiated by, in one non-limiting example, a third-party provider of electronic payment and transaction-processing services, although insurance provider 130 may initiate the memo post without a third-party provider. If there are errors at this step, a message is returned to the member 105 that transfer is not available at this time and the member 105 should try again later. In step 621, Primary bank 115 initiates an overnight transfer of funds from member 105 HSA account to financial institution 180 affiliated with insurance provider 130 through an Automated Clearing House type transaction, or similar. Once payment is received by financial institution 180, then in step 623, the payment that was originally negotiated between the insurance provider 130 is remitted to healthcare provider 150 either through regular mail or electronically by using the funds received from the HSA account.

Going back to step 617, if the HSA account balance is less than the patient liability, then in step 625, the membership system server 140 determines whether the account balance is greater than zero. If the answer is yes, then in step 627, insurance provider 130 initiates a memo post transaction through membership system server 140 and sends this to Primary bank 115 in order to hold the funds available to cover a portion of the patient liability associated with member account. The memo post may be initiated by, in one non-limiting example, a third-party provider of electronic payment and transaction-processing services, although insurance provider 130 may initiate the memo post without a third-party provider. If there are errors at this step, a message is returned to the member 105 that transfer is not available at this time and the member 105 should try again later. In step 629, Primary bank 115 initiates an overnight transfer of funds from member 105 HSA account to financial institution 180 affiliated with insurance provider 130. Next, in step 631, the third-party provider of electronic payment and transaction processing services initiates a credit-card transaction with member's financial institution 175 to authorize payment for the remaining portion of the patient liability. Once payment is received by financial institution 180, then in step 633, the payment that was originally negotiated between the insurance provider 130 and the healthcare provider 150 is remitted to healthcare provider 150 either through regular mail or electronically by partly using the funds received from the HSA account, partly using the funds received through the credit care transaction, and partly using the insurance provider 130 funds. However, going back to step 617, if the HSA account balance is less than zero, then a message is sent to member 105 that the account balance is exhausted and the process ends in step 607.

While the invention has been described with reference to the preferred embodiment and several alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the invention is capable of being embodied in other forms without departing from its essential characteristics.

What is claimed is:

1. A system for member reimbursement of insurance claims, said system comprising:
an insurance system server for storing information regarding a member account, and for receiving information regarding reimbursement of insurance claims,
wherein said insurance system server is of or associated with a third-party, and
wherein said information regarding reimbursement is received from a computer of or associated with a member;
a first financial institution server for generating information regarding a health savings account, wherein said health savings account is of or associated with said member; and
a second financial institution computer for receiving electronic transfer of funds from said health savings account,
wherein said system determines whether said insurance claim is selected for reimbursement,
wherein said system initiates an electronic funds transfer from said health savings account to said second financial institution if said insurance claim is selected for reimbursement.

2. The system of claim 1, wherein said system is configured to determine whether said insurance claim includes patient liability exceeding a predetermined threshold.

3. The system of claim 2, wherein said system transmits information regarding selection of said insurance claim for payment, wherein said information regarding said selection of said insurance claim is transmitted if said exceeds said predetermined threshold.

4. The system of claim 3, wherein said system is configured for receiving data regarding changes to said information in said member account, wherein said data is transmitted from said computer of or associated with said member.

5. The system of claim 4, further comprising a telephone for receiving information regarding changes to said information in said member account.

6. The system of claim 4, wherein said system is configured for issuing a debit card associated with information in said health savings account.

7. The system of claim 6, wherein said system is configured for receiving information regarding said health savings account from said first financial institution server.

8. A system for provider reimbursement of insurance claims, said system comprising:
an insurance system server for storing information regarding a member, and for receiving information regarding reimbursement of insurance claims,
wherein said insurance system server is of or associated with a third-party, and
wherein said information regarding reimbursement of insurance claims is received from a computer of or associated with a member;
a first financial institution server for generating information regarding a health savings account, wherein said health savings account is of or associated with said member; and
a second financial institution computer for receiving electronic funds from said health savings account, and for receiving funds from one of a debit or credit card account of or associated with said member,
wherein said system determines whether said insurance claim is selected for reimbursement, and determines whether said insurance claim meets a predetermined criteria,
wherein said system initiates an electronic funds transfer from said health savings account to said second financial institution if said insurance claim is selected for reimbursement and said insurance claim meets said predetermined criteria.

9. The system of claim 8, wherein aid predetermined criteria is at least one of patient liability exceeding zero, consumer driven health plan eligible, membership account available, or service date within effective data.

10. The system of claim 9, wherein said system receives information regarding an account balance in said health savings account.

11. The system of claim 10, wherein said system is configured to determine whether said account balance exceeds member liability.

12. The system of claim 11, wherein said system initiates an electronic funds transfer from said health savings account if said account balance exceeds said member liability.

13. The system of claim 12, wherein said system is configured to determine whether said account balance exceeds zero if said account balance does not exceed said member liability.

14. The system of claim 13, wherein said system initiates a transfer of funds equal to said account balance from said flexible account if said account balance does not exceed said member liability.

15. The system of claim 13, wherein said system authorizes a charge against one of said debit or credit card for a difference in said account balance and said member liability.

16. The system of claim 15, wherein said system transmits information regarding selection of said insurance claim for payment, wherein said information regarding said selection of said insurance claim is transmitted if said member liability exceeds said predetermined threshold.

17. The system of claim 16, wherein said system is configured for receiving data regarding changes to said information in said member account, wherein said data is transmitted from said computer of or associated with said member.

18. The system of claim 17, further comprising a telephone for receiving information regarding changes to said information in said member account.

19. The system of claim 18, wherein said system is configured for issuing a debit card associated with information in said health savings account.

20. The system of claim 18, wherein said system is configured for receiving information regarding said health savings account from said first financial institution server.

21. A computer method for automated payment of insurance claims, comprising:
storing, via a storage device, information regarding a member;
receiving, via a receiver, information regarding reimbursement of insurance claims, wherein said insurance system server is of or associated with a third-party, and wherein said information regarding reimbursement of insurance claims is received from a computer of or associated with a member;
generating, via a first processor, information regarding a health savings account, wherein said health savings account is of or associated with said member;
receiving, via said receiver, electronic funds from said health savings account, and funds from one of a debit or credit card account of or associated with said member;
determining, via said processor, whether said insurance claim is selected for reimbursement, and determining whether said insurance claim meets a predetermined criteria; and
initiating, via said processor, an electronic funds transfer from said health savings account to said second financial institution if said insurance claim is selected for reimbursement and said insurance claim meets said predetermined criteria.

22. The method of claim 21, wherein said predetermined criteria is at least one of patient liability exceeding zero, consumer driven health plan eligible, membership account available, or service date within effective data.

23. The method of claim 22, further comprising receiving information regarding an account balance in said health savings account.

24. The method of claim 23, further comprising determining whether said account balance exceeds a member liability.

25. The method of claim 24, further comprising initiating an electronic funds transfer from said health savings account if said account balance exceeds said member liability.

26. The method of claim 25, further comprising determining whether said account balance exceeds zero if said account balance does not exceed said member liability.

27. The method of claim 26, further comprising initiating a transfer of funds equal to said account balance from said flexible account if said account balance does not exceed said member liability.

28. The method of claim 27, further comprising authorizing a charge against said credit card for a difference in said account balance and said member liability.

29. The method of claim 28, further comprising transmitting information regarding selection of said insurance claim for payment, wherein said information regarding said selection of said insurance claim is transmitted if said member liability exceeds said predetermined threshold.

30. The method of claim 29, further comprising receiving data regarding changes to said information in said member account, wherein said data is transmitted from said computer of or associated with said member.

31. The method of claim 30, further comprising receiving information regarding changes to said information in said member account.

32. The method of claim 31, further comprising issuing a debit card associated with information in said health savings account.

33. The method of claim 31, further comprising receiving information regarding said health savings account from said first financial institution server.
